(19) United States
(12) Patent Application Publication
(10) Pub. No.: US 2014/0344257 A1
(43) Pub. Date: Nov. 20, 2014

(54) Detecting a Preferred Implementation of an Operation

(71) Applicant: International Business Machines Corporation, Armonk, NY (US)

(72) Inventors: Robert E. Loredo, North Miami Beach, FL (US); Luisito D. Pineda, Nashua, NH (US)

(73) Assignee: International Business Machines Corporation, Armonk, NY (US)

(21) Appl. No.: 13/895,652

(22) Filed: May 16, 2013

(51) Int. Cl. G06F 17/30

(52) U.S. Cl. CPC G06F 17/3053
USPC 707/723

(57) ABSTRACT

A mechanism is provided for detecting a preferred implementation for executing a specified operation associated with a specified application. Responsive to receiving a request to identify the preferred implementation for executing the specified operation associated with the specified application, execution of the specified application is monitored on a plurality of computing devices. For each of the plurality of computing devices, responsive to detecting that the specified operation has been executed within the specified application, a set of user actions utilized to implement the specified operation are recorded. The set of user actions for each instance of implementing the specified operation on the plurality of computing devices is analyzed and results of the analysis are ranked based on the preferred implementation of executing the specified operation.

### BACKGROUND

The present application relates generally to an improved data processing apparatus and method and more specifically to mechanisms for detecting the preferred implementation for executing an operation associated with an application.

A tutorial is a method of transferring knowledge and may be used as a part of a learning process. More interactive and specific than a book or a lecture, a tutorial seeks to teach by example and supply the information to complete a certain task. Depending on the context, a tutorial may take one of many forms, ranging from a set of instructions to complete a task or operation to an interactive problem solving session (usually in academia).

### SUMMARY

In one illustrative embodiment, a method, in a data processing system, is provided for detecting a preferred implementation for executing a specified operation associated with a specified application. The illustrative embodiment monitors the execution of the specified application on a plurality of computing devices in response to receiving a request to identify the preferred implementation for executing the specified operation associated with the specified application. For each of the plurality of computing devices, the illustrative embodiment records a set of user actions utilized to implement the specified operation in response to detecting that the specified operation has been executed within the specified application. The illustrative embodiment analyzes the set of user actions for each instance of implementing the specified operation on the plurality of computing devices. The illustrative embodiment ranks results of the analysis based on the preferred implementation of executing the specified operation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a function block diagram of a preferred implementation detection mechanism in accordance with an illustrative embodiment;

FIG. 4 depicts a flowchart of an operation performed by a preferred implementation detection mechanism to identify a preferred implementation of a specified operation or task for a specified application in accordance with an illustrative embodiment;

FIG. 5 depicts a flowchart of an operation performed by a preferred implementation detection mechanism to resent results for an identification of a preferred implementation of a specified operation or task for a specified application in accordance with an illustrative embodiment;

FIG. 6 depicts a flowchart of an operation performed by a preferred implementation detection mechanism to detect changes to a preferred implementation of a specified operation or task for a specified application in accordance with an illustrative embodiment; and

FIG. 7 depicts a flowchart of an operation performed by a preferred implementation detection mechanism to automatically implement changes to a tutorial in response to detecting a difference of a currently preferred implementation of a specified operation or task for a specified application from a previous preferred implementation of a specified operation or task for a specified application in accordance with an illustrative embodiment.

### DETAILED DESCRIPTION

As stated previously, a tutorial is a method of transferring knowledge and may be used as a part of a learning process. Within a tutorial, a presenter provides information and/or directions with regard to performing a specific task or operation. However, when preparing the tutorial, the presenter has to know what task or operation is to be performed as well as other information, such as alternative implementations for performing the task or operation that provide the same result. Furthermore, the presenter also has to know who the audience is. That is, whether the tutorial will be utilized primarily by a developer, a user, or some other individual. Therefore, the illustrative embodiments provide a mechanism that detects the preferred implementation for executing an operation associated with an application across a plurality of different individuals and for different groups of individuals.

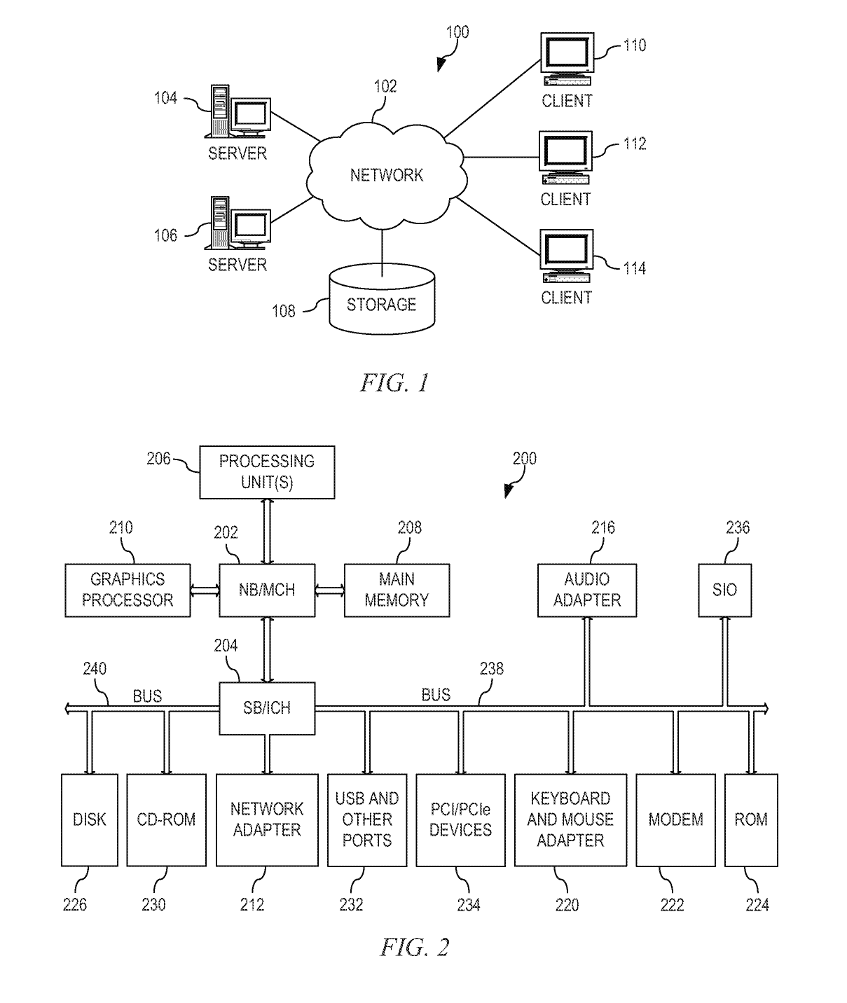

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive) (AIX®)operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

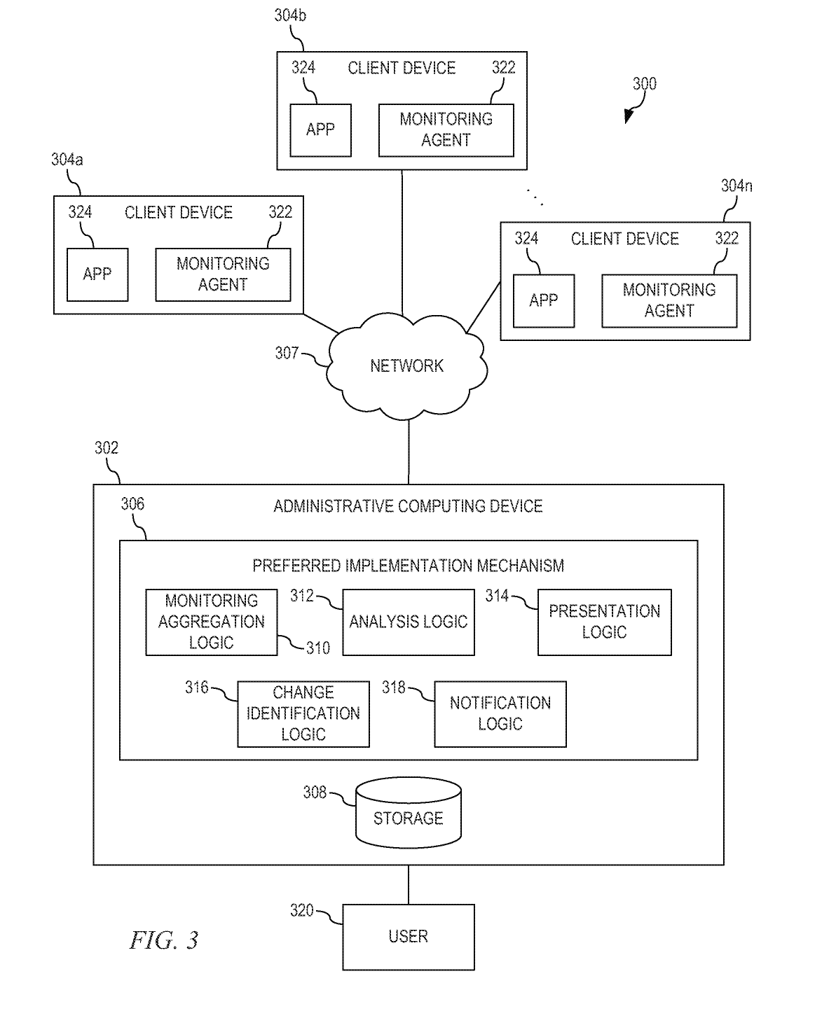

FIG. 3 depicts a function block diagram of a preferred implementation detection mechanism in accordance with an illustrative embodiment. Distributed data processing system 300 comprises an administrative computing device 302 as well as one or more client computing devices 304a-304n coupled via network 307. Administrative computing device 302 comprises preferred implementation detection mechanism 306 and storage device 308. Preferred implementation detection mechanism 306 further comprises monitoring aggregation logic 310, analysis logic 312, presentation logic 314, change identification logic 316, and notification logic 318.

In operation, user 320 submits a request to preferred implementation detection mechanism 306 to identify a preferred implementation of a specified operation or task for a specified application. For example, the user may be in the process of preparing a tutorial for changing a selected portion of text within document to an Italic format. The illustrative embodiments recognize that, with at least regard to a word processing application, there are many ways to change a selected portion of text to the Italic format, such as selecting the portion of text and depressing both the “Control” key and the “I” key on a keyboard, selecting the portion of text and selecting the “Italic” tab from a menu, selecting the portion of text and selecting a font style from a font menu, or the like.

Therefore, with the specified operation or task identified as well as the specified application identified, monitoring aggregation logic 310 within (preferred implementation detection mechanism 306 initializes monitoring agents 322 on one or more client computing devices 304a-304n to monitor the use of the specified application 324 and, more specifically, the implementation of the specified operation or task for a predefined monitoring timeframe. Monitoring agents 322 are logic agents that may exist as logic within the operating system of client computing devices 304a-304n, may exist as logic within application 324 deployed on client computing devices 304a-304n, may exist as part of a monitoring system within an enterprise system and, as such, is only deployed temporarily when an administrator needs information from client computing devices 304a-304n, or the like. With monitoring agents 322 initialized, when one or more users of client computing devices 304a-304n starts specified application 324 and performs the specified operation or task, monitoring agents 322 record the specified implementation as well as information associated with the user of application 324 and application 324 itself. That is, with regard to application 324, monitoring agents 322 may record a phase of the application 324 (i.e., whether the application is in design, test, production, or the like), a version of application 324, an operating system that application 324 is being executed on, or the like. Further, with regard to the user of application 324, monitoring agents may record an identity of the user, a user's position with the enterprise (i.e., subject-matter expert (SME), poweruser, tester, standard user, or the like), whether the user is a random user of a shared device (i.e., device in a library, Internet café, etc.), or the like. With the information recorded, monitoring agents 322 that have detected the implementation of the specified operation or task, sends recorded information pertaining to the specified operation or task back to monitoring aggregation logic 310. Monitoring aggregation logic 310 then stores the specified operation or task information in storage 308.

Once monitoring aggregation logic 310 stores the received specified operation or task information in storage 308, analysis logic 312 analyzes the specified operation or task information based on one or more user predefined criteria, such as the phase of application 324, the version of application 324, the operating system that application 324 is being executed on, the user's position with the enterprise, whether the user is a random user of a shared device, or the like. That is, based on the one or more criteria, analysis logic 312 may group results pertaining to, for example with regard to the implementation of the Italic format, the user's position with the enterprise such that analysis logic 312 identifies that a group of testers implement the Italic format by selecting the portion of text and selecting a font style from font menu, while powerusers implement the Italic format by selecting the portion of text and selecting the “Italic” tab from a menu, and the subject-matter experts implement the Italic format by selecting the portion of text and depressing both “Control” key and the “I” key on a keyboard. Thus, analysis logic 312 analyzes and scores how groups of users perform the specified operation or task. It should be noted that while the above example provides analysis based solely on the user's position with the enterprise, the illustrative embodiments are not limited to analysis based on one criterion. That is, in accordance with the illustrative embodiments, analysis logic 312 may provide an analysis of just one or more than one of any of the above exemplified criteria or any criteria that is currently known or may be recognized in the future without departing from the spirit and scope of the invention. With the specified operation or task information properly analyzed based on the user predefined criteria, analysis logic 312 stores the results in storage 308 and presentation logic 314 presents the results of the analysis to user 320 via a graphical user interface, a printer, or some other mechanism in which result in formation may be resented to user 320.

As is commonly known in the art, how a person implements an operation or task on one day may not be the same way the user implements the operation or task a year later, a month later, a week later, a day later, or even an hour later. Thus, preferred implementation detection mechanism 306 also provides change identification logic 316 to detect changes in previous preferred implementations of a specified operation or task for a specified application requests. Thus, at predetermined intervals, change identification logic 316 may initialize monitoring agents 322 on one or more client computing devices 304a-304n to monitor the use of the previously specified application and, more specifically, the implementation of the previously specified operation or task. Following the same operation previously described above, monitoring agents 322 that have detected the implementation of a previously specified operation or task, send recorded information pertaining to the previously specified operation or task back to monitoring aggregation logic 310. Monitoring aggregation logic 310 then stores the specified operation or task information as new information in storage 308. Change identification logic 316 then initializes analysis logic 312 to perform an analysis of the new information based on the same criteria used in the previously request. However, rather than presentation logic 314 presenting the unsolicited results to the user, change identification logic 316 compares the results of the analysis of the new information to the previously presented results of the analysis of the old information. If the currently preferred implementation differs from the previous preferred implementation, then change identification logic 316 initializes notification logic 318 to notify user 320 that the preferred implementation has changed.

In addition to the above, so that user 320 does not have to rerecord each tutorial every time a preferred implementation has changed, user 320 may have recorded individual segments of the tutorial that may be blended together by change identification logic 316. That is, user 320 may have recorded a plurality of different title pages, frames, clips, or the like, for each of the one or more user predefined criteria; an introductory set of pages, frames, clips, or the like, that are common to all tutorials; a plurality of different implementation pages, frames, clips, or the like, with regard to each possible implementation of the specified operation or task; as well as a conclusion set of pages, frames, clips, or the like, that are common to all tutorials. Therefore, rather than notifying the user of changes that occur if the currently preferred implementation differs from the previous preferred implementation, if there is a predetermined setting that indicates that change identification logic 316 should automatically make changes without notifying the user, change identification logic 316 may remove, as an example, a hyperlink to a current tutorial that is available for powerusers, blend together a new tutorial using the currently identified preferred implementation, and hyperlink the newly blended tutorial for availability to the powerusers. Upon completion, change identification logic 316 may notify user 320 of the change, so that user 320 may review the changes.

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is nota computer readable storage medium and that can communicate, propagate, or transport a program for use by or in connection with an instruction execution system, apparatus, or device. Similarly, a computer readable storage medium is any computer readable medium that is not a computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

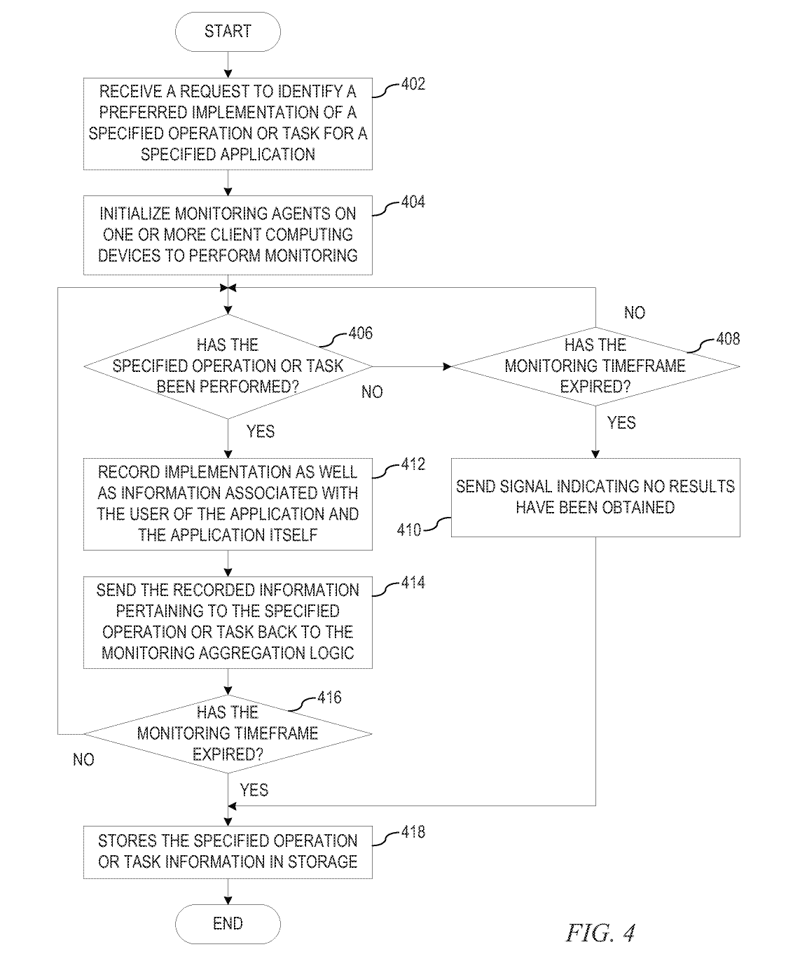

FIG. 4 depicts a flowchart of an operation performed by a preferred implementation detection mechanism to identify a preferred implementation of a specified operation or task for a specified application in accordance with an illustrative embodiment. As the operation begins, the preferred implementation detection mechanism receives a request to identify a preferred implementation of a specified operation or task for a specified application (step 402). Monitoring aggregation logic within preferred implementation detection mechanism initializes monitoring agents on one or more client computing devices to monitor the use of the specified application and, more specifically, the implementation of the specified operation or task (step 404). Each of the monitoring agents then determines whether the specified operation or task has been performed by the specified application of the client device on which the monitoring application resides (step 406). If at step 406 the monitoring agent does not detect the implementation of the specified operation in the specified application, then the monitoring agent determines whether the monitoring timeframe has expired (step 408).

If at step 408 the monitoring agent determines that the monitoring timeframe has not expired, then the operation returns to step 406. If at step 408 the monitoring agent determines that the monitoring timeframe has expired, then the monitoring agent returns a signal to the monitoring aggregation logic indicating no results have been obtained (step 410). If at step 406 the monitoring agent detects the implementation of the specified operation in the specified application, the monitoring agent records the specific implementation of the specified operation or task as well as information associated with the user of the application and the application itself (step 412). The monitoring agent sends the recorded information pertaining to the specified operation or task back to the monitoring aggregation logic (step 414). The monitoring agent determines whether the monitoring timeframe has expired (step 416).

If at step 416 the monitoring agent determines that the monitoring timeframe has not expired, then the operation returns to step 406. If at step 416 the monitoring agent determines that the monitoring timeframe has expired or from step 410, the monitoring aggregation logic stores the specified operation or task information in storage (step 418), with the operation ending thereafter.

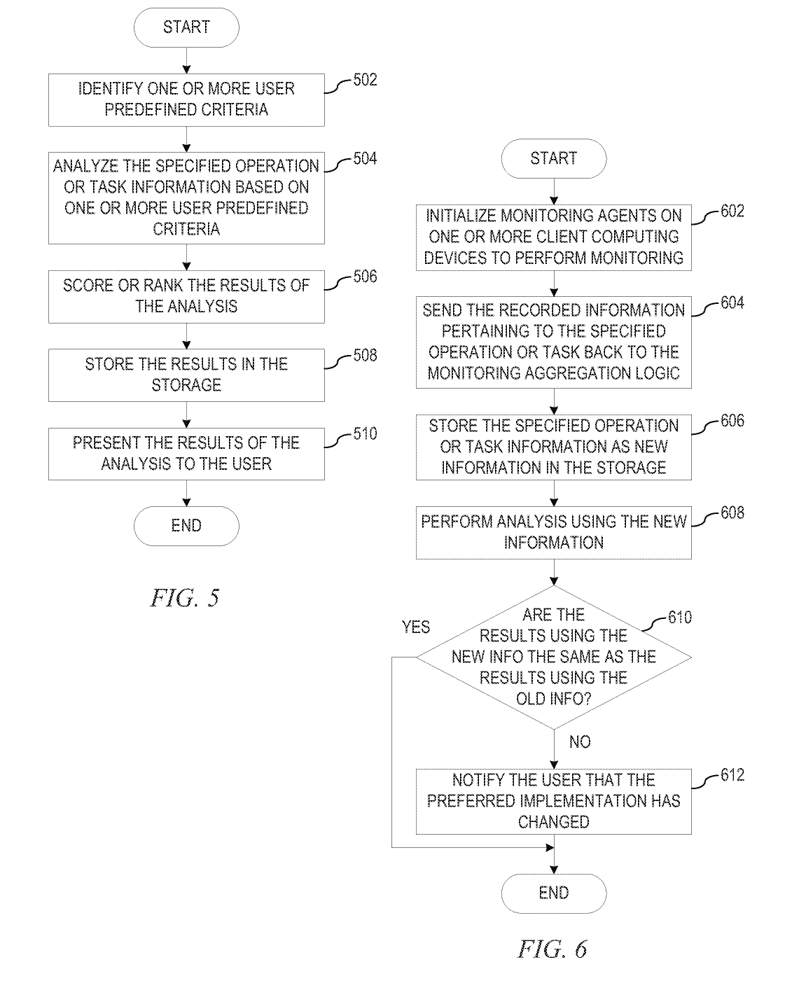

FIG. 5 depicts a flowchart of an operation performed by a preferred implementation detection mechanism to resent results for an identification of a preferred implementation of a specified operation or task for a specified application in accordance with an illustrative embodiment. As the operation begins, analysis logic within the preferred implementation detection mechanism identifies one or more user predefined criteria from the user (step 502). The analysis logic then analyzes the specified operation or task information based on one or more user predefined criteria (step 504). The analysis logic then scores or ranks the results of the analysis (step 506), stores the results in the storage (step 508), and presents the results of the analysis to the user (step 510), with the operation ending thereafter.

FIG. 6 depicts a flowchart of an operation performed by a preferred implementation detection mechanism to detect changes to a preferred implementation of a specified operation or task for a specified application in accordance with an illustrative embodiment. As the operation begins, at predetermined intervals after an initial invocation of a request to identify a preferred implementation of a specified operation or task for a specified application, change identification logic within the preferred implementation detection mechanism initializes the monitoring agents on the one or more client computing devices to monitor the use of the previously specified application and, more specifically, the implementation of the previously specified operation or task (step 602). Following the same operation previously described above with regard to FIG. 4, the monitoring agents that have detected the implementation of a previously specified operation or task, sends recorded information pertaining to the previously specified operation or task back to the monitoring aggregation logic (step 604). The monitoring aggregation logic then stores the specified operation or task information as new information in the storage (step 606).

The change identification logic then initializes the analysis logic to perform an analysis as previously described above with regard to FIG. 5 but using the new information (step 608). The change identification logic compares the results of the analysis of the new information to the previously presented results of the analysis of the old information (step 610). If at step 610 the change identification logic to detect a difference of the currently preferred implementation of a specified operation or task for a specified application from the previous preferred implementation of a specified operation or task for a specified application, then the operation terminates until the next predetermined interval. If at step 610 the change identification logic detects a difference of the currently preferred implementation of a specified operation or task Dora specified application from the previous preferred implementation of a specified operation or task Dora specified application, then the change identification logic initializes notification logic to notify the user that the preferred implementation has changed (step 612), with the operation terminating thereafter.

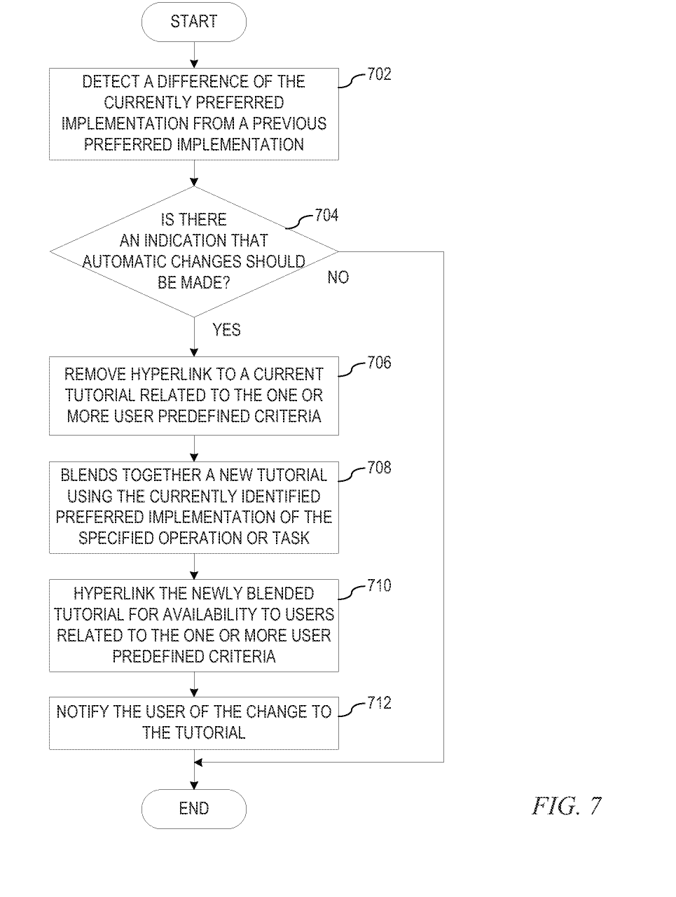

FIG. 7 depicts a flowchart of an operation performed by a preferred implementation detection mechanism to automatically implement changes to a tutorial in response to detecting a difference of a currently preferred implementation of a specified operation or task for a specified application from a previous preferred implementation of a specified operation or task for a specified application in accordance with an illustrative embodiment. As the operation begins, the change identification logic detects a difference of the currently preferred implementation of a specified operation or task for a specified application from the previous preferred implementation of a specified operation or task for a specified application (step 702). The change identification logic then determines whether an indication has been made indicating automatic changes to a current tutorial should be made (step 704). If at step 704 the change identification logic determines that no indication exists to make automatic changes to a current tutorial, then the operation terminates.

If at step 704 the change identification logic determines that an indication does exist to make automatic changes to a current tutorial, the change identification logic removes a hyperlink to a current tutorial related to the one or more user predefined criteria (step 706). The change identification logic blends together a new tutorial using the currently identified preferred implementation of the specified operation or task using previously user recorded pages, frames, clips, or the like (step 708). The change identification logic then hyperlinks the newly blended tutorial for availability to users related to the one or more user predefined criteria (step 710). The change identification logic then notifies the user of the change to the tutorial (step 712), with the operation terminating thereafter.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for detecting the preferred implementation for executing an operation associated with an application across a plurality of different individuals and for different groups of individuals. The results of the detection may be based on one or more predefined criteria. The results may be presented to the user or a new tutorial may be automatically generated if indicated by the user.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for detecting a preferred implementation for executing a specified operation associated with a specified application, the method comprising:
responsive to receiving a request to identify the preferred implementation for executing the specified operation associated with the specified application, monitoring the execution of the specified application on a plurality of computing devices;
for each of the plurality of computing devices, responsive to detecting that the specified operation has been executed within the specified application, recording a set of user actions utilized to implement the specified operation;
analyzing the set of user actions for each instance of implementing the specified operation on the plurality of computing devices; and
ranking results of the analysis based on the preferred implementation of executing the specified operation.

2. The method of claim 1, further comprising:
for each of the plurality of computing devices, recording information associated with a user of the specified application and information associated with the specified application itself thereby forming a set of criteria; and
grouping the results of the analysis based on the preferred implementation of executing the specified operation and one or more of the set of criteria.

3. The method of claim 2, wherein the information associated with the user of the specified application is at least one of an identity of the user, a user's position with an enterprise, or whether the user is a random user of a shared computing device and wherein the information associated with the specified application itself is at least one of a phase of the specified application, a version of specified application, or an operating system that the specified application is being executed on.

4. The method of claim 1, further comprising:
presenting the results of the analysis based on the preferred implementation of executing the specified operation.

5. The method of claim 1, further comprising:
responsive to a predetermined time interval being met, monitoring the executing of the specified application on the plurality of computing devices;
for each of the plurality of computing devices, responsive to detecting that the specified operation has been executed within the specified application, recording a subsequent set of user actions utilized to implement the specified operation;
analyzing the subsequent set of user actions for each instance of implementing the specified operation on the plurality of computing devices;
ranking results of the analysis based on the preferred implementation of executing the specified operation thereby forming a new preferred implementation;
comparing the new preferred implementation to a previously preferred implementation; and
responsive to the new preferred implementation differing from the previously preferred implementation, notifying a user of a difference of the new preferred implementation to the previously preferred implementation.

6. The method of claim 1, further comprising:
responsive to detecting a difference of a new preferred implementation from a previously preferred implementation, replacing a previous tutorial utilizing the previously preferred implementation with a new tutorial utilizing the new preferred tutorial.

7. The method of claim 6, wherein replacing the previous tutorial utilizing the previously preferred implementation with the new tutorial utilizing the new preferred tutorial comprises:
removing a hyperlink to the previous tutorial;
blending together the new tutorial using the new preferred implementation of the specified operation or task using previously user recorded pages, frames, or clips; and
hyperlinking the new tutorial for availability to users related to a set of criteria.

8. The method of claim 7, wherein the previously user recorded pages, frames, or clips comprises one or more of a plurality of different title pages, frames, or clips for each of one or more user predefined criteria; an introductory set of pages, frames, or clips that are common to all tutorials; a plurality of different implementation pages, frames, or clips with regard to each possible implementation of the specified operation or task; or a conclusion set of pages, frames, or clips that are common to all tutorials.

9. A computer program product comprising a computer readable storage medium having a computer readable program stored therein, wherein the computer readable program, when executed on a computing device, causes the computing device to:
responsive to receiving a request to identify a preferred implementation for executing a specified operation associated with a specified application, monitor the execution of the specified application on a plurality of computing devices;
for each of the plurality of computing devices, responsive to detecting that the specified operation has been executed within the specified application, record a set of user actions utilized to implement the specified operation;
analyze the set of user actions for each instance of implementing the specified operation on the plurality of computing devices; and
rank results of the analysis based on the preferred implementation of executing the specified operation.

10. The computer program product of claim 9, wherein the computer readable program further causes the computing device to:
for each of the plurality of computing devices, record information associated with a user of the specified application and information associated with the specified application itself thereby forming a set of criteria; and
group the results of the analysis based on the preferred implementation of executing the specified operation and one or more of the set of criteria.

11. The computer program product of claim 9, wherein the computer readable program further causes the computing device to:
present the results of the analysis based on the preferred implementation of executing the specified operation.

12. The computer program product of claim 9, wherein the computer readable program further causes the computing device to:
responsive to a predetermined time interval being met, monitor the executing of the specified application on the plurality of computing devices;
for each of the plurality of computing devices, responsive to detecting that the specified operation has been executed within the specified application, record a subsequent set of user actions utilized to implement the specified operation;
analyze the subsequent set of user actions for each instance of implementing the specified operation on the plurality of computing devices;
rank results of the analysis based on the preferred implementation of executing the specified operation thereby forming a new preferred implementation;
compare the new preferred implementation to a previously preferred implementation; and
responsive to the new preferred implementation differing from the previously preferred implementation, notify a user of a difference of the new preferred implementation to the previously preferred implementation.

13. The computer program product of claim 9, wherein the computer readable program further causes the computing device to:
responsive to detecting a difference of a new preferred implementation from a previously preferred implementation, replace a previous tutorial utilizing the previously preferred implementation with a new tutorial utilizing the new preferred tutorial.

14. The computer program product of claim 13, wherein the computer readable program to replace the previous tutorial utilizing the previously preferred implementation with the new tutorial utilizing the new preferred tutorial further causes the computing device to:
remove a hyperlink to the previous tutorial;
blend together the new tutorial using the new preferred implementation of the specified operation or task using previously user recorded pages, frames, or clips; and
hyperlink the new tutorial for availability to users related to a set of criteria.

15. An apparatus comprising:
a processor; and
a memory coupled to the processor, wherein the memory comprises instructions which, when executed by the processor, cause the processor to:
responsive to receiving a request to identify a preferred implementation for executing a specified operation associated with a specified application., monitor the execution of the specified application on a plurality of computing devices;
for each of the plurality of computing devices, responsive to detecting that the specified operation has been executed within the specified application, record a set of user actions utilized to implement the specified operation;
analyze the set of user actions for each instance of implementing the specified operation on the plurality of computing devices; and
rank results of the analysis based on the preferred implementation of executing the specified operation.

16. The apparatus of claim 15, wherein the instructions further cause the processor to:
for each of the plurality of computing devices, record information associated with a user of the specified application and information associated with the specified application itself thereby forming a set of criteria; and
group the results of the analysis based on the preferred implementation of executing the specified operation and one or more of the set of criteria.

17. The apparatus of claim 15, wherein the instructions further cause the processor to:
present the results of the analysis based on the preferred implementation of executing the specified operation.

18. The apparatus of claim 15, wherein the instructions further cause the processor to:
responsive to a predetermined time interval being met, monitor the executing of the specified application on the plurality of computing devices;
for each of the plurality of computing devices, responsive to detecting that the specified operation has been executed within the specified application, record a subsequent set of user actions utilized to implement the specified operation;
analyze the subsequent set of user actions for each instance of implementing the specified operation on the plurality of computing devices;
rank results of the analysis based on the preferred implementation of executing the specified operation thereby forming a new preferred implementation;
compare the new preferred implementation to a previously preferred implementation; and
responsive to the new preferred implementation differing from the previously preferred implementation, notify a user of a difference of the new preferred implementation to the previously preferred implementation.

19. The apparatus of claim 15, wherein the instructions further cause the processor to:
responsive to detecting a difference of a new preferred implementation from a previously preferred implementation, replace a previous tutorial utilizing the previously preferred implementation with a new tutorial utilizing the new preferred tutorial.

20. The apparatus of claim 19, wherein the instructions to replace the previous tutorial utilizing the previously preferred implementation with the new tutorial utilizing the new preferred tutorial further cause the processor to:
remove a hyperlink to the previous tutorial;
blend together the new tutorial using the new preferred implementation of the specified operation or task using previously user recorded pages, frames, or clips; and
hyperlink the new tutorial for availability to users related to a set of criteria.
